(19) United States
(12) Patent Application Publication
(10) Pub. No.: US 2025/0220465 A1
(43) Pub. Date: Jul. 3, 2025

(54) COMMUNICATION DEVICE, COMMUNICATION METHOD, CONTROL CIRCUIT, AND STORAGE MEDIUM

(71) Applicant: Mitsubishi Electric Corporation, Tokyo (JP)

(72) Inventors: Shusaku UMEDA, Tokyo (JP); Mari OCHIAI, Tokyo (JP); Yuji AKIYAMA, Tokyo (JP); Akinori TAIRA, Tokyo (JP); Manabu SAKAI, Tokyo (JP)

(73) Assignee: Mitsubishi Electric Corporation, Tokyo (JP)

(21) Appl. No.: 19/085,592

(22) Filed: Mar. 20, 2025

Related U.S. Application Data
(63) Continuation of application No. PCT/JP2022/042036, filed on Nov. 11, 2022.

(51) Int. Cl. H04W 24/04; H04W 8/00; H04W 76/10

(52) U.S. Cl. CPC H04W 24/04; H04W 8/005; H04W 76/10

(57) ABSTRACT

A communication device has a function of directly communicating with a communication terminal that is another communication device, and includes: a base station search unit that searches for base stations with which direct communication is possible; a communication control unit that performs a connection process for connecting to base stations searched for by the base station search unit to construct redundantly-configured communication paths; and a communication terminal search unit that searches for the communication terminal connected to a base station, and in a case where the number of direct communications with base stations established is less than the number required for constructing the redundantly-configured communication paths, the communication control unit establishes indirect communication with a base station via a communication terminal searched for by the communication terminal search unit to construct redundantly-configured communication paths.

### CROSS-REFERENCE TO RELATED APPLICATION

This application is a continuation application of International Application PCT/JP2022/042036, filed on Nov. 11, 2022, and designating the U.S., the entire contents of which are incorporated herein by reference.

### BACKGROUND OF THE INVENTION

### 1. Field of the Invention

The present disclosure relates to a communication device, a communication method, a control circuit, and a storage medium.

### 2. Description of the Related Art

As a possible means for realizing fully automated driving of an automobile under a specific environment (level 4 automated driving), there is dynamic mapping of overlaying dynamic information including a situation of a surrounding mobile object on a three-dimensional map as static information. Requisite communication for implementation of dynamic mapping is required to be highly reliable communication compared to normal communication. Therefore, in 3rd Generation Partnership Project (3GPP) (registered trademark), a redundant configuration has been studied in which a communication device installed on an automobile communicates with a plurality of base stations, and highly reliable communication can be realized by transmitting dynamic information through a plurality of paths.

On the other hand, a redundant configuration with a plurality of base stations may not be realized due to a communication environment, accommodation capacity, a geographical problem, and the like, and in that case, communication interruption and fallback operation are considered. In a case of the operation in the communication interruption and the fallback operation, sufficient reliability cannot be ensured, and thus, an alternative redundancy means is required.

As a technique for solving this problem, Non Patent Literature 1, 3GPP TR 23.700-33, “Study on system enhancement for Proximity based Services (ProSe) in the 5G System (5GS); Phase 2”, discloses a redundant configuration in which direct communication with a base station and indirect communication with the base station using a relay by another mobile station are combined.

However, the technique described in the above Non Patent Literature 1 can realize indirect communication via a mobile station designated by a base station only, and the above Non Patent Literature 1 does not describe a method for selecting, by a mobile station that desires to realize a redundant configuration, a mobile station that performs a relay process for realizing indirect communication. In a case of an automobile using dynamic mapping, when a mobile station for realizing indirect communication is not directly selected by a communication device installed on the automobile, provision of dynamic information is delayed due to an influence of a communication delay, and a delay required for dynamic mapping cannot be achieved.

### SUMMARY OF THE INVENTION

In order to solve the above-described problems and achieve an object, the present disclosure is a communication device having a function of directly communicating with a communication terminal that is another communication device. The communication device includes: a base station search unit to search for base stations with which direct communication is possible; a communication control unit to perform a connection process for connecting to base stations searched for by the base station search unit to construct redundantly-configured communication paths; and a communication terminal search unit to search for the communication terminal connected to a base station. In a case where a number of direct communications with base stations established is less than a number required for constructing the redundantly-configured communication paths, the communication control unit establishes indirect communication with a base station via the communication terminal searched for by the communication terminal search unit to construct redundantly-configured communication paths.

### BRIEF DESCRIPTION OF THE DRAWINGS

FIG. 1 is a diagram illustrating an exemplary configuration of a communication system according to a first embodiment;

FIG. 2 is a diagram illustrating an example of a functional block configuration of a communication device according to the first embodiment that realizes mobile stations;

FIG. 3 is a diagram illustrating an example of an operation flow of the communication system according to the first embodiment;

FIG. 4 is a flowchart illustrating an example of an operation of the mobile station according to the first embodiment;

FIG. 5 is a diagram illustrating an exemplary configuration of a communication system according to a second embodiment;

FIG. 6 is a diagram illustrating an example of an operation flow of the communication system according to the second embodiment;

FIG. 7 is a diagram illustrating an example of an operation flow of a communication system according to a third embodiment;

FIG. 8 is a flowchart illustrating an example of an operation of the mobile station according to the third embodiment;

FIG. 9 is a diagram illustrating an exemplary configuration of a communication system according to a fourth embodiment;

FIG. 10 is a diagram illustrating an example of an operation flow of the communication system according to the fourth embodiment;

FIG. 11 is a flowchart illustrating an example of an operation of the mobile station according to the fourth embodiment; and

FIG. 12 is a diagram illustrating an exemplary configuration of a processing circuitry in a case where a communication unit of the communication device is realized by a processor and a memory.

### DETAILED DESCRIPTION OF THE PREFERRED EMBODIMENTS

Hereinafter, a communication device, a communication method, a control circuit, and a storage medium according to each embodiment of the present disclosure will be described in detail with reference to the drawings.

### First Embodiment

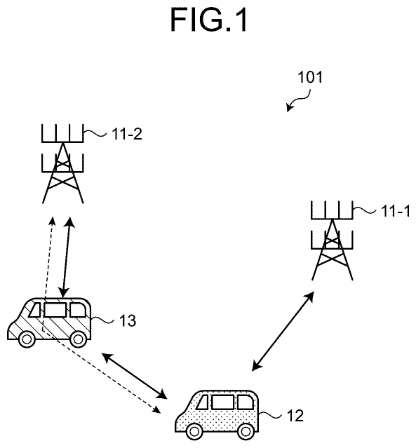

FIG. 1 is a diagram illustrating an exemplary configuration of a communication system 101 according to a first embodiment. The communication system 101 is a 5G communication system, in detail, a 5G communication system having the indirect communication function described in Non Patent Literature 1, 3GPP TR 23.700-33, “Study on system enhancement for Proximity based Services (ProSe) in the 5G System (5GS); Phase 2”, implemented therein and capable of constructing a redundant configuration using the indirect communication function.

The communication system 101 includes base stations 11-1 and 11-2 and mobile stations 12 and 13. The mobile stations 12 and 13 have a function of performing direct communication without going through a base station, and are operable as relay stations that relay signals between a base station being connected and a counterpart station of the direct communication. Note that FIG. 1 illustrates, among the components of the communication system 101, only the components necessary for describing the first embodiment. For example, base stations other than the base stations 11-1 and 11-2, mobile stations other than the mobile stations 12 and 13, a core network to which the base stations 11-1 and 11-2 are connected, and the like are not illustrated.

The base station 11-1 is a base station that is in direct communication with the mobile station 12. The base station 11-2 is a base station that is in direct communication with the mobile station 13, but is in a state of being unable to perform direct communication with the mobile station 12.

The mobile station 12 is a mobile station that desires to realize a redundant configuration of communication paths, and is a mobile object such as an automobile on which the communication device according to the first embodiment is installed. That is, the mobile station 12 includes a mobile object and a communication device installed on the mobile object. The mobile station 12 is a mobile station that requests mission critical communication, for example, dynamic mapping. The mobile station 12 attempts to realize a redundant configuration, but cannot perform direct communication with a plurality of base stations, and attempts to realize the redundant configuration using indirect communication via surrounding mobile stations in combination. In the present embodiment, the mobile station 12 is in a state where direct communication with the base station 11-1 can be performed, but direct communication with the base station 11-2 cannot be performed. Therefore, the mobile station 12 performs indirect communication with the base station 11-2 via the mobile station 13 capable of performing direct communication with the base station 11-2.

Similarly to the mobile station 12, the mobile station 13 includes a mobile object and a communication device installed on the mobile object. The mobile station 13 is in direct communication with the base station 11-2, and operates as a relay station that performs a relay process when the mobile station 12 indirectly communicates with the base station 11-2.

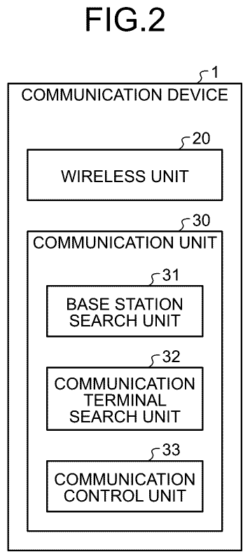

FIG. 2 is a diagram illustrating an example of a functional block configuration of a communication device 1 according to the first embodiment that realizes the mobile stations 12 and 13.

As illustrated in FIG. 2, the communication device 1 according to the first embodiment includes a wireless unit 20 that transmits and receives a wireless signal to and from another communication device, and a communication unit 30 that performs transmission and reception of a control signal and a data signal to and from another communication device via the wireless unit 20, and the like. The communication device 1 is configured to be able to simultaneously communicate with a plurality of other communication devices. That is, the wireless unit 20 can simultaneously transmit wireless signals to and from a plurality of other communication devices, and the communication unit 30 can simultaneously communicate with a plurality of other communication devices. The communication unit 30 includes a base station search unit 31 that searches for a base station with which direct communication can be performed, a communication terminal search unit 32 that searches for a communication terminal with which direct communication can be performed such as a mobile object on which another communication device is installed, and a communication control unit 33 that controls communication operations with the base station and the communication terminal.

Note that, in each the mobile stations 12 and 13, the communication device 1 performs communication processes with the base stations 11-1 and 11-2 and the like having a communication function, but in order to prevent the description from becoming complicated, the mobile stations 12 and 13 will be described in the following description as subjects that execute the communication processes.

Next, an operation of the communication system 101 will be described. Specifically, an operation will be described in which the mobile station 12 constructs the redundant configuration illustrated in FIG. 1 by combining direct communication with the base station 11-1 and indirect communication with the base station 11-2 via the mobile station 13.

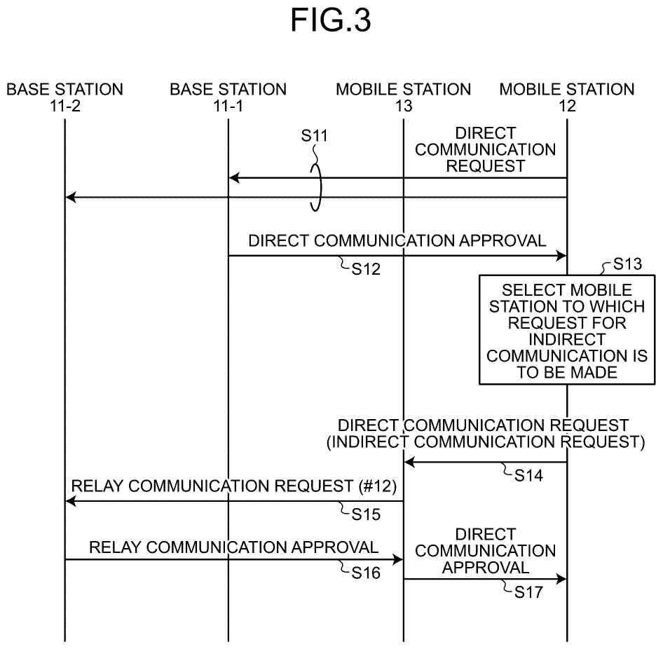

FIG. 3 is a diagram illustrating an example of an operation flow of the communication system 101 according to the first embodiment. In detail, FIG. 3 is a sequence diagram illustrating an example of an operation in which when the mobile station 12 constructs redundant communication paths between the mobile station 12 and the base station, indirect communication with the base station 11-2 led by the mobile station 12 is started, and thereby redundancy of communication paths is provided.

In the operation of providing redundancy of communication paths illustrated in FIG. 3, the mobile station 12 first transmits a direct communication request to the base stations 11-1 and 11-2 to realize a redundant configuration through direct communication (step S11).

At that time, in response to the direct communication request from the mobile station 12, only the base station 11-1 accepts the request and returns a direct communication approval to the mobile station 12, and direct communication is established therebetween (step S12). Note that there are no base stations other than the base stations 11-1 and 11-2 in a range in which the mobile station 12 can perform direct communication. In FIG. 3, the base station 11-2 does not transmit a response signal to the mobile station 12, but may return a response signal for rejecting the direct communication request. In a case where the response signal for rejecting the direct communication request is not transmitted from the base station 11-2, the mobile station 12 determines, when a certain period of time has elapsed from the transmission of the direct communication request in step S11, that the direct communication request is rejected.

Since direct communication with the base station 11-2 cannot be established, the mobile station 12 switches to establishing a redundant configuration using indirect communication in combination. Then, the mobile station 12 searches for surrounding mobile stations, and selects, from among mobile stations that have been found, a mobile station to which a request for indirect communication is to be made (step S13). When searching for surrounding mobile stations, the mobile station 12 also collects information on base stations to which the mobile stations are connected. That is, the mobile station 12 acquires, from each of the mobile stations found by the search, information on the base station with which the found mobile station has established direct communication.

Here, the mobile station 12 selects the mobile station 13 connected to the base station 11-2. The mobile station 12 transmits, to the selected mobile station 13, a direct communication request including a request for indirect communication with the base station 11-2 (step S14). Note that the direct communication request transmitted by the mobile station 12 in step S14 is a request for direct communication with the mobile station 13.

The mobile station 13 accepts the direct communication request received from the mobile station 12, and transmits, to the base station 11-2 that the mobile station 13 is directly communicating with, a relay communication request for data directed to the mobile station 12 (step S15). Note that there may be a case where the mobile station 13 rejects the direct communication request from the mobile station 12, but an operation in the case of rejection is not covered by the present disclosure, and thus the description thereof will be omitted. Similarly, there may be a case where the base station 11-2 rejects the relay communication request from the mobile station 13, but an operation in the case of rejection is not covered by the present disclosure, and thus description thereof will be omitted.

The base station 11-2 accepts the relay communication request received from the mobile station 13, and returns a relay communication approval (step S16). Upon receiving the relay communication approval from the base station 11-2, the mobile station 13 transmits, to the mobile station 12, a direct communication approval for the direct communication request from the mobile station 12 (step S17). At that time, the mobile station 13 transmits an approval for the request for indirect communication with the base station 11-2, as well. That is, in step S17, the mobile station 13 transmits, to the mobile station 12, the direct communication approval including the approval for the request for indirect communication with the base station 11-2. As a result, indirect communication via the mobile station 13 is established between the base station 11-2 and the mobile station 12.

By operating as described above, the mobile station 12 that has not been able to realize a redundant configuration through direct communication with the base station 11-2 can select an appropriate mobile station 13 from among the surrounding mobile stations and establish indirect communication with the base station 11-2 via the selected mobile station 13.

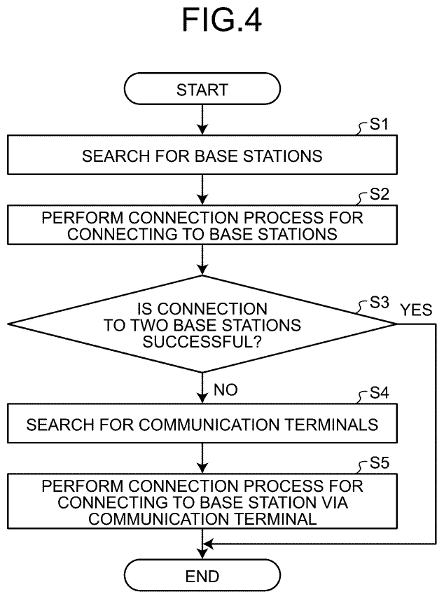

Here, an operation of the mobile station 12 of the communication system 101 according to the first embodiment is as illustrated in a flowchart of FIG. 4. FIG. 4 is a flowchart illustrating an example of the operation of the mobile station 12 according to the first embodiment.

In a case where the mobile station 12 constructs a redundant communication path to the base station, the mobile station 12 first searches for base stations present in a range in which direct communication can be performed (step S1). In detail, the base station search unit 31 transmits a signal for searching for base stations and receives a response signal thereto, thereby finding base stations with which direct communication can be performed.

Next, the mobile station 12 performs a connection process for connecting to base stations (step S2). In detail, the communication control unit 33 selects two base stations to be used for constructing redundant communication paths from among the base stations found by the base station search unit 31, and performs a process for connecting to the two selected base stations. In a case where the number of base stations found by the base station search unit 31 is three or more, the communication control unit 33 selects, for example, two base stations with good wireless communication quality, for example, two base stations from which high-power signals are received. Note that the selection method is not limited thereto.

If the connection to the two base stations is successful (step S3: Yes), the mobile station 12 has been able to construct the redundant configuration of the communication paths through direct communication with the two base stations, and thus ends the operation.

If the connection to the two base stations is not successful, that is, if the connection to at least one of the selected two base stations has failed (step S3: No), the mobile station 12 searches for communication terminals (step S4). In detail, the communication terminal search unit 32 searches for communication terminals which are surrounding mobile stations or the like with which direct communication can be performed. Note that the communication terminal does not need to be a mobile station, and may be, for example, a road side unit installed on a road. When searching for communication terminals, the communication terminal search unit 32 collects information on base stations with which the found communication terminals have established direct communication.

From among the communication terminals found in step S4, the mobile station 12 selects a communication terminal to which an operation as a relay station that performs a relay process is to be requested, and performs a connection process for connecting to the base station via the selected communication terminal (step S5). In detail, the communication control unit 33 selects a communication terminal directly connected to the base station that the communication control unit 33 has failed to connect to in step S2, and requests the selected communication terminal to operate as a relay station that realizes indirect communication with the base station. In a case where there are a plurality of communication terminals directly connected to the base station that the communication control unit 33 has failed to connect to in step S2, the communication control unit 33 selects any one of the communication terminals. In that case, the communication control unit 33 selects a communication terminal capable of realizing indirect communication with good communication quality on the basis of, for example, the wireless communication quality between the mobile station 12 and each communication terminal and the wireless communication quality between each communication terminal and the base station. When connection to the selected communication terminal is completed and indirect communication with the base station via the selected communication terminal is enabled to be performed, the mobile station 12 ends the operation.

Note that, in a case where the number of base stations found in step S1 described above is three or more and connection to the two base stations selected in step S2 has failed, the mobile station 12 may reselect a base station to be a connection destination and perform the connection process again. The mobile station 12 executes step S4 in a case where connection has been attempted to all the base stations found in step S1 and the number of base stations to which connection is successful is one or less. In addition, in a case of failing in connection to all the base stations to which the connection has been attempted in step S2, that is, in a case where there is no base station with which direct communication can be performed, the mobile station 12 may construct two communication paths using indirect communication with the base station in step S5.

In step S5 described above, the mobile station 12 selects the communication terminal directly connected to the base station the connection to which has failed in step S2 and requests the selected communication terminal to operate as a relay station, but may select a communication terminal directly connected to a base station different from the base station the connection to which has failed in step S2. For example, the mobile station 12 may preferentially select a communication terminal capable of realizing indirect communication with good communication quality without considering whether the communication terminal is a communication terminal directly connected to the base station the connection to which has failed in step S2.

As described above, in the communication system 101 according to the present embodiment, in a case where the mobile station 12 that desires redundancy of the communication paths cannot realize a redundant configuration by establishing direct communication with each of the plurality of base stations, the mobile station 12 searches for a communication terminal that has established direct communication with the base station, and establishes direct communication with a communication terminal that has been found, thereby establishing indirect communication with the base station via the communication terminal to construct a redundant configuration. Consequently, in a case where the redundant configuration of the communication paths is realized by using indirect communication, the mobile station 12 can select a communication terminal operating as a relay station that performs a relay process of the indirect communication.

### Second Embodiment

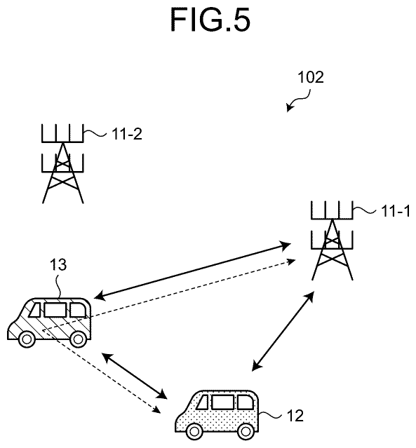

FIG. 5 is a diagram illustrating an exemplary configuration of a communication system 102 according to a second embodiment. The communication system 102 has a configuration similar to the communication system 101 according to the first embodiment, but a base station with which the mobile station 12 performs indirect communication is different from that of the first embodiment. In detail, in the communication system 102 according to the second embodiment, the mobile station 12 performs indirect communication with the base station 11-1 via the mobile station 13. That is, the mobile station 12 performs indirect communication with the base station 11-1 via the mobile station 13 while performing direct communication with the base station 11-1.

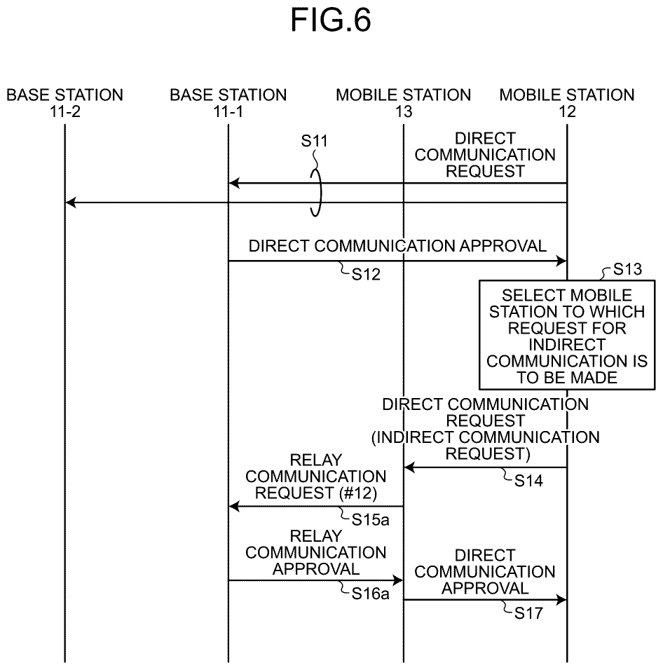

FIG. 6 is a diagram illustrating an example of an operation flow of the communication system 102 according to the second embodiment. In detail, FIG. 6 is a sequence diagram illustrating an example of an operation in which when the mobile station 12 constructs redundant communication paths between the mobile station 12 and the base station, indirect communication with the base station 11-1 led by the mobile station 12 is started, and thereby redundancy of the communication paths is provided. In FIG. 6, the same processes as those described in the operation flow of the communication system 101 according to the first embodiment of FIG. 3 are denoted by the same step numbers. Descriptions of processes denoted by the same step numbers as those in FIG. 3 will not be repeated.

In the communication system 102, since the mobile station 13 that receives the direct communication request including the indirect communication request from the mobile station 12 is connected to the base station 11-1, the mobile station 13 transmits, to the base station 11-1, a relay communication request for data directed to the mobile station 12 (step S15a). The base station 11-1 accepts the relay communication request received from the mobile station 13, and returns a relay communication approval (step S16a).

Since the operation of the mobile station 12 is similar to that in the first embodiment, the description thereof will not be repeated.

By operating as described above, when the mobile station 12 that has not been able to realize the redundant configuration through direct communication selects an appropriate mobile station from among the surrounding mobile stations, even in a case where the mobile station 12 selects another mobile station 13 connected to the same base station as that the mobile station 12 is connected to, a plurality of communication paths can be prepared, and the redundant configuration can be realized.

### Third Embodiment

The configuration of a communication system according to a third embodiment is similar to that in the first embodiment. In the communication system according to the third embodiment, after a mobile station realizes a redundant configuration through direct communication and indirect communication with base stations, the mobile station again attempts to establish direct communication with a base station with which direct communication has not been able to be established, and in a case where direct communication can be established, the mobile station ends the indirect communication and shifts to a redundant configuration through the two direct communications.

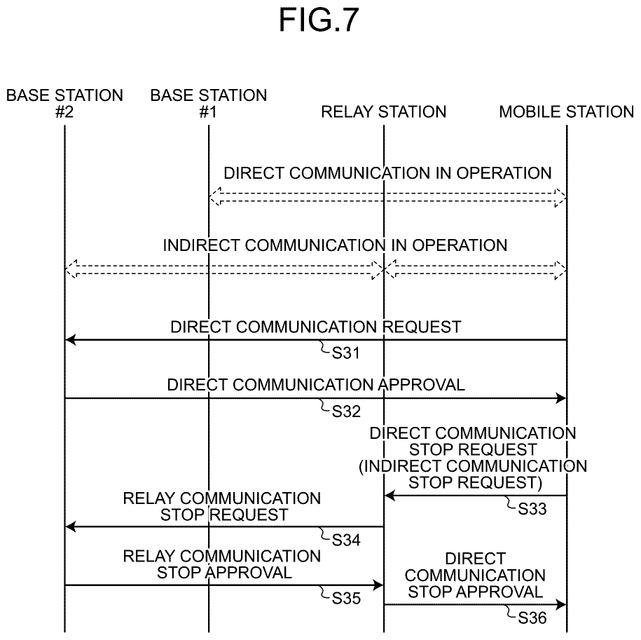

FIG. 7 is a diagram illustrating an example of an operation flow of the communication system according to the third embodiment. In the example illustrated in FIG. 7, base station #1, base station #2, a mobile station, and a relay station constitute the communication system. In FIG. 7, base station #1 corresponds to the base station 11-1 of the first embodiment, and base station #2 corresponds to the base station 11-2 of the first embodiment. The mobile station corresponds to the mobile station 12 of the first embodiment, and the relay station corresponds to the mobile station 13 of the first embodiment. The mobile station performs direct communication with base station #1 and performs indirect communication with base station #2 via the relay station.

As illustrated in FIG. 7, the mobile station transmits a direct communication request to base station #2 at a predetermined timing while indirectly communicating with base station #2 via the relay station (step S31). The mobile station periodically transmits the direct communication request to base station #2 until direct communication with base station #2 is established, for example. Step S31 is a process similar to step S11 illustrated in FIG. 3 and the like.

In a case where base station #2 can accept the direct communication request, base station #2 returns a direct communication approval to the mobile station (step S32). Consequently, direct communication between the mobile station and base station #2 is established. When the direct communication with base station #2 is established, the mobile station determines to stop the indirect communication with base station #2, and transmits, to the relay station, a direct communication stop request including a request for stop of indirect communication with base station #2 (step S33). The relay station transmits a relay communication stop request to base station #2 in indirect communication with the mobile station (step S34). Base station #2 that has received the relay communication stop request accepts the request, and returns a relay communication stop approval to the relay station (step S35). Upon receiving the relay communication stop approval from base station #2, the relay station transmits, to the mobile station, a direct communication stop approval for the direct communication stop request from the mobile station (step S36). At that time, the relay station transmits an approval for the stop of indirect communication with base station #2, as well. That is, in step S36, the relay station transmits, to the mobile station, the direct communication stop approval including the approval for the stop of indirect communication with base station #2. Consequently, the indirect communication between the mobile station and base station #2 via the relay station ends.

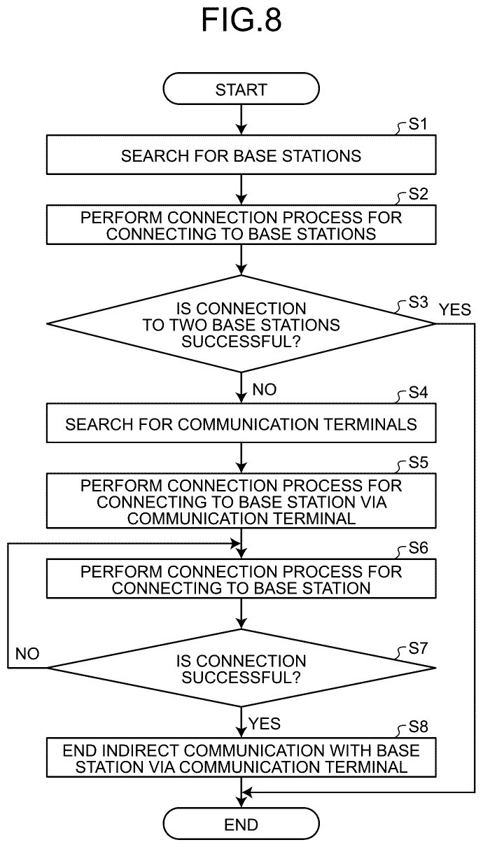

An operation of the mobile station according to the present embodiment is as illustrated in a flowchart of FIG. 8. FIG. 8 is a flowchart illustrating an example of an operation of the mobile station according to the third embodiment. In FIG. 8, processes common to those in the flowchart of FIG. 4 illustrating the operation of the mobile station 12 according to the first embodiment are denoted by the same step numbers as those in FIG. 4. The descriptions of the processes denoted by the same step numbers as those in FIG. 4 (the processes of steps S1 to S5) will not be repeated.

After executing the process of step S5, the mobile station according to the third embodiment performs a connection process for connecting to the base station (step S6). In step S6, the mobile station performs a connection process for connecting to the base station with which direct communication has not been able to be established by the connection process performed in step S2. If the connection to the base station is successful, that is, if direct communication with the base station is established (step S7: Yes), the mobile station ends the indirect communication with the base station via the communication terminal operating as the relay station (step S8), and the operation ends. If the connection to the base station has failed (step S7: No), the mobile station returns to step S6 and performs the connection process for connecting to the base station again.

As described above, after realizing the redundant configuration using the indirect communication, the mobile station according to the present embodiment again executes at a predetermined timing the process of establishing direct communication with the base station with which direct communication has not been able to be established, and in a case where direct communication can be established, the mobile station ends the indirect communication. Consequently, it is possible to shift from a redundant configuration through a combination of direct communication and indirect communication to a redundant configuration only through direct communication.

Note that, in the present embodiment, the process of establishing direct communication is executed again for the base station for which the establishment of direct communication has failed. However, the mobile station may execute a search for surrounding base stations, and when finding a base station with which direct communication has not been able to be established, the mobile station may execute again the process of establishing direct communication for the found base station.

### Fourth Embodiment

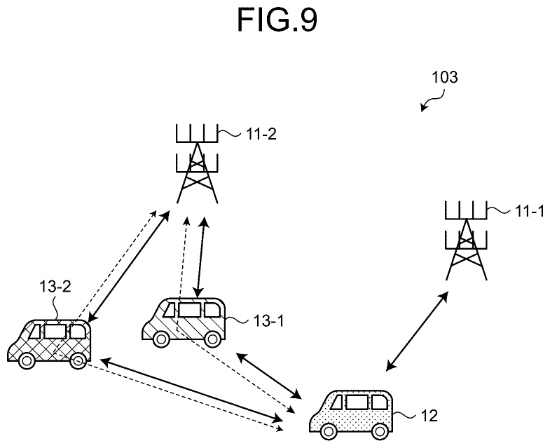

FIG. 9 is a diagram illustrating an exemplary configuration of a communication system 103 according to a fourth embodiment. The communication system 103 is a 5G communication system similar to the communication system 101 according to the first embodiment illustrated in FIG. 1. In FIG. 9, components common to those of the communication system 101 according to the first embodiment are denoted by the same reference numerals.

The communication system 103 includes the base stations 11-1 and 11-2, the mobile station 12 that constructs redundantly-configured communication paths, and mobile stations 13-1 and 13-2 that operate as relay stations in the redundantly-configured communication paths to be constructed by the mobile station 12.

In the communication system 103, the mobile station 12 constructs a communication path with each of the base stations 11-1 and 11-2, but cannot establish direct communication with the base station 11-2. Therefore, the mobile station 12 establishes indirect communication with the base station 11-2 via each of the mobile stations 13-1 and 13-2. A difference in the communication system 103 from the communication system 101 according to the first embodiment is that a path of indirect communication is duplicated.

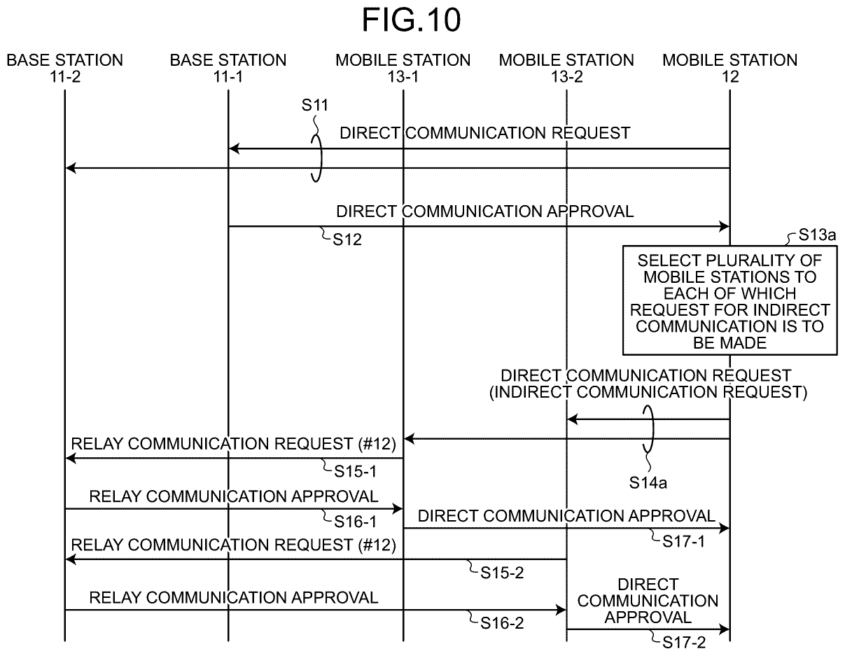

FIG. 10 is a diagram illustrating an example of an operation flow of the communication system 103 according to the fourth embodiment. In FIG. 10, the same processes as those described in the operation flow of the communication system 101 according to the first embodiment of FIG. 3 are denoted by the same step numbers. Descriptions of processes denoted by the same step numbers as those in FIG. 3 will not be repeated.

After receiving the direct communication approval from the base station 11-1 in step S12, the mobile station 12 selects a plurality of mobile stations to each of which a request for indirect communication is to be made (step S13a). Specifically, the mobile station 12 selects two of the mobile stations 13-1 and 13-2 as mobile stations to each of which a request for indirect communication is to be made. In a case where it is possible to select only one mobile station to which a request for indirect communication is to be made, the mobile station 12 selects one mobile station to which a request for indirect communication is to be made. In that case, the operation is similar to that in the first embodiment.

The mobile station 12 transmits, to the selected mobile stations 13-1 and 13-2, a direct communication request including a request for indirect communication with the base station 11-2 (step S14a).

The mobile stations 13-1 and 13-2 each accept the direct communication request received from the mobile station 12, and transmit, to the base station 11-2 that the mobile stations 13-1 and 13-2 are directly communicating with, a relay communication request for data directed to the mobile station 12 (steps S15-1 and S15-2).

The base station 11-2 accepts the relay communication requests received from the mobile stations 13-1 and 13-2, and returns relay communication approvals (steps S16-1 and S16-2). Upon receiving the relay communication approval from the base station 11-2, the mobile stations 13-1 and 13-2 each transmit, to the mobile station 12, a direct communication approval for the direct communication request from the mobile station 12 (steps S17-1 and S17-2). At that time, the mobile stations 13-1 and 13-2 each transmit an approval for the request for indirect communication with the base station 11-2, as well. That is, in step S17-1, the mobile station 13-1 transmits, to the mobile station 12, the direct communication approval including the approval for the request for indirect communication with the base station 11-2. In step S17-2, the mobile station 13-2 transmits, to the mobile station 12, the direct communication approval including the approval for the request for indirect communication with the base station 11-2. As a result, indirect communication via the mobile station 13-1 and indirect communication via the mobile station 13-2 are established between the base station 11-2 and the mobile station 12.

By operating as described above, the mobile station 12 that has not been able to realize the redundant configuration through direct communication selects a plurality of appropriate mobile stations from among the surrounding mobile stations to establish indirect communication, and a redundant configuration stronger than that of the first embodiment can be realized.

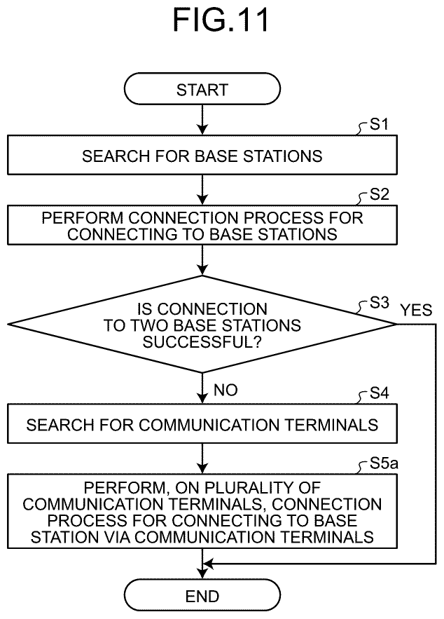

An operation of the mobile station 12 according to the present embodiment is as illustrated in a flowchart of FIG. 11. FIG. 11 is a flowchart illustrating an example of an operation of the mobile station 12 according to the fourth embodiment. In FIG. 11, processes common to those in the flowchart of FIG. 4 illustrating the operation of the mobile station 12 according to the first embodiment are denoted by the same step numbers as those in FIG. 4. Descriptions of processes with the same step numbers as those in FIG. 4 will not be repeated.

After searching for communication terminals in step S4, from among the communication terminals found in step S4, the mobile station 12 according to the fourth embodiment selects a plurality of communication terminals to each of which a request to operate as a relay station that performs a relay process is to be made, and performs, on the selected plurality of communication terminals, a connection process for connecting to the base station 11-2 via the communication terminals (step S5a). Specifically, the mobile station 12 selects the mobile stations 13-1 and 13-2 and performs a connection process for connecting to the base station 11-2.

As described above, in the communication system 103 according to the present embodiment, in a case where direct communication with a base station cannot be established and indirect communication is established, the mobile station 12 selects a plurality of mobile stations from among mobile stations found by performing a search, and establishes a plurality of indirect communications via respective selected mobile stations. Consequently, it is possible to realize communication with higher reliability than the communication system 101 according to the first embodiment in which the redundant configuration is realized by using a single indirect communication instead of direct communication.

Note that, in the communication system 103 illustrated in FIG. 9, both the mobile station 13-1 and the mobile station 13-2 operating as relay stations are connected to the base station 11-2, but there is no limitation to this connection form. At least one of the mobile station 13-1 and the mobile station 13-2 may be connected to the base station 11-1. That is, the mobile station 13-1 and the mobile station 13-2 operating as relay stations may be connected to the same base station as that the mobile station 12 that has requested indirect communication is connected to, or may be connected to a base station different therefrom. In addition, a base station to which the mobile station 13-1 is connected and a base station to which the mobile station 13-2 is connected may be different from each other.

Next, a hardware configuration of the communication device 1 constituting the mobile station 12 that has been described in each embodiment will be described. The wireless unit 20 of the communication device 1 is realized by a transceiver. The communication unit 30 of the communication device 1 is realized by processing circuitry which is dedicated hardware, specifically, a single circuit, a composite circuit, a programmed processor, a parallel programmed processor, an application specific integrated circuit (ASIC), a field programmable gate array (FPGA), or processing circuitry obtained by combining these.

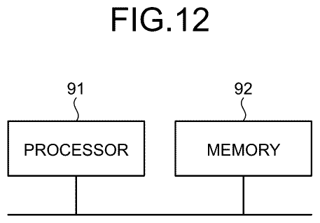

In addition, the processing circuitry that realizes the communication unit 30 of the communication device 1 may be a control circuit including a processor that executes a program stored in a memory and the memory. FIG. 12 is a diagram illustrating an exemplary configuration of processing circuitry in a case where the communication unit 30 of the communication device 1 is realized by a processor and a memory. A processor 91 is a central processing unit (CPU, also referred to as a central processing device, a processing device, an arithmetic device, a microprocessor, a microcomputer, a processor, and a digital signal processor (DSP)) or the like. A memory 92 is, for example, a random access memory (RAM), a read only memory (ROM), a flash memory, an erasable programmable read only memory (EPROM), or an electrically erasable programmable read only memory (EEPROM (registered trademark)).

The communication unit 30 of the communication device 1, that is, the base station search unit 31, the communication terminal search unit 32, and the communication control unit 33 are realized by the processor 91 and the memory 92. That is, programs for operating as the base station search unit 31, the communication terminal search unit 32, and the communication control unit 33 are stored in the memory 92, and the processor 91 reads and executes the programs, and thereby the communication unit 30 of the communication device 1 is realized.

Note that some of components of the communication unit 30 of the communication device 1 may be realized by dedicated hardware, and the rest of the components may be realized by the processor 91 and the memory 92 illustrated in FIG. 12. In a case where some or all of the components of the communication unit 30 of the communication device 1 are realized by the processor 91 and the memory 92, programs stored in the memory 92 may be provided to a user or the like, for example, in a state of being written in a storage medium such as a compact disc (CD)-ROM or a digital versatile disc (DVD)-ROM, or may be provided via a network.

The communication device according to the present disclosure achieves an effect that, in a case of realizing a redundant configuration of communication paths by combining direct communication and indirect communication, a communication system can be realized in which a mobile station that desires to realize a redundant configuration can select a relay station that performs a relay process of indirect communication.

The configurations described in the above embodiments are merely examples and can be combined with other known technology, the embodiments can be combined with each other, and part of the configurations can be omitted or modified without departing from the gist thereof. For example, in each embodiment, the number of base stations with which the mobile station 12 establishes direct communication is two, but the number of base stations with which the mobile station establishes direct communication may be three or more.

What is claimed is:

1. A communication device having a function of directly communicating with a communication terminal that is another communication device, the communication device comprising:
base station search circuitry to search for base stations with which direct communication is possible;
communication control circuitry to perform a connection process for connecting to base stations searched for by the base station search circuitry to construct redundantly-configured communication paths; and
communication terminal search circuitry to search for the communication terminal connected to a base station, wherein
in a case where a number of direct communications with base stations established is less than a number required for constructing the redundantly-configured communication paths, the communication control circuitry establishes indirect communication with a base station via the communication terminal searched for by the communication terminal search circuitry to construct redundantly-configured communication paths.

2. The communication device according to claim 1, wherein
the communication terminal search circuitry collects information on a base station to which the communication terminal searched for is connected, and
the communication control circuitry selects a communication terminal that executes a relay process of the indirect communication on a basis of the information on the base station collected by the communication terminal search circuitry.

3. The communication device according to claim 2, wherein
the communication control circuitry selects, from among communication terminals searched for by the communication terminal search circuitry, a communication terminal directly connected to a base station for which establishment of direct communication has failed, and establishes indirect communication via the selected communication terminal.

4. The communication device according to claim 1, wherein
after establishing the indirect communication, the communication control circuitry executes a connection process for establishing direct communication with a base station, and in a case where the direct communication with the base station is successfully established, the communication control circuitry ends the indirect communication.

5. The communication device according to claim 2, wherein
after establishing the indirect communication, the communication control circuitry executes a connection process for establishing direct communication with a base station, and in a case where the direct communication with the base station is successfully established, the communication control circuitry ends the indirect communication.

6. The communication device according to claim 3, wherein
after establishing the indirect communication, the communication control circuitry executes a connection process for establishing direct communication with a base station, and in a case where the direct communication with the base station is successfully established, the communication control circuitry ends the indirect communication.

7. The communication device according to claim 1, wherein
the communication control circuitry selects a plurality of communication terminals from among communication terminals searched for by the communication terminal search circuitry, and establishes a plurality of indirect communications each via one of the plurality of selected communication terminals.

8. The communication device according to claim 2, wherein
the communication control circuitry selects a plurality of communication terminals from among communication terminals searched for by the communication terminal search circuitry, and establishes a plurality of indirect communications each via one of the plurality of selected communication terminals.

9. The communication device according to claim 3, wherein
the communication control circuitry selects a plurality of communication terminals from among communication terminals searched for by the communication terminal search circuitry, and establishes a plurality of indirect communications each via one of the plurality of selected communication terminals.

10. The communication device according to claim 4, wherein
the communication control circuitry selects a plurality of communication terminals from among communication terminals searched for by the communication terminal search circuitry, and establishes a plurality of indirect communications each via one of the plurality of selected communication terminals.

11. The communication device according to claim 5, wherein
the communication control circuitry selects a plurality of communication terminals from among communication terminals searched for by the communication terminal search circuitry, and establishes a plurality of indirect communications each via one of the plurality of selected communication terminals.

12. The communication device according to claim 6, wherein
the communication control circuitry selects a plurality of communication terminals from among communication terminals searched for by the communication terminal search circuitry, and establishes a plurality of indirect communications each via one of the plurality of selected communication terminals.

13. A communication method executed by a communication device having a function of directly communicating with a communication terminal that is another communication device, the communication method comprising:
a base station search of searching for base stations with which direct communication is possible;
a communication control of performing a connection process for connecting to base stations searched for in the base station search to construct redundantly-configured communication paths; and
a communication terminal search of searching for the communication terminal connected to a base station, wherein
in the communication control, in a case where a number of direct communications with base stations established is less than a number required for constructing the redundantly-configured communication paths, indirect communication with a base station via a communication terminal searched for in the communication terminal search is established to construct redundantly-configured communication paths.

14. A control circuit that controls a communication device having a function of directly communicating with a communication terminal that is another communication device, the control circuit causing the communication device to execute:
a base station search of searching for base stations with which direct communication is possible;
a communication control of performing a connection process for connecting to base stations searched for in the base station search to construct redundantly-configured communication paths; and
a communication terminal search of searching for the communication terminal connected to a base station, wherein
in a case where a number of direct communications with base stations established is less than a number required for constructing the redundantly-configured communication paths, the communication control includes a process of establishing indirect communication with a base station via a communication terminal searched for in the communication terminal search to construct redundantly-configured communication paths.

15. A non-transitory storage medium that stores a program for controlling a communication device having a function of directly communicating with a communication terminal that is another communication device,
the program causing the communication device to execute:
a base station search of searching for base stations with which direct communication is possible;
a communication control of performing a connection process for connecting to base stations searched for in the base station search to construct redundantly-configured communication paths; and
a communication terminal search of searching for the communication terminal connected to a base station, wherein
in a case where a number of direct communications with base stations established is less than a number required for constructing the redundantly-configured communication paths, the communication control includes a process of establishing indirect communication with a base station via a communication terminal searched for in the communication terminal search to construct redundantly-configured communication paths.
